(19) United States
(12) Patent Application Publication
(10) Pub. No.: US 2005/0289016 A1
(43) Pub. Date: Dec. 29, 2005

(54) Personal electronic repository

(76) Inventors: Cay Horstmann, San Francisco, CA (US); Michael J. Ure, Cupertino, CA (US)

Correspondence Address: Michael Ure, P.O. Box 2187, Cupertino, CA, 95015-2187, US

(21) Appl. No.: 10/868,427

(22) Filed: Jun. 15, 2004

(51) Int. Cl. G06F 17/60

(52) U.S. Cl. 705/27

(57) ABSTRACT

The present invention, generally speaking, provides for a personal electronic repository, or electronic “shoebox,” that receives electronic information from disparate sources and automatically organizes that information in such a way as to enable the owner to readily view the collection of electronic information, find a desired piece of information, act upon a piece of information, etc., all in a secure and controlled way. As opposed to email, which is episodic in nature, the personal electronic repository is thematic in nature. Furthermore, as opposed to personal information management, which is factual in nature, the personal electronic repository is well-suited for information that is transactional in nature. A further characteristic of the shoebox is its long-term nature. Email can be archived, but few individuals expend a concerted effort towards that goal. Personal information management records are fleeting—when a user changes a calendar item or ticks off a to-do item, it's gone. But the shoebox can keep material around for years, so that, for example, the executor of a deceased's estate can locate the deceased's estate documents readily, or divorcing spouses can trace their premarital income. These characteristics (thematic, transactional, long-term) characterize what may be referred to as “life information management,” or “elife.”

### BACKGROUND OF THE INVENTION

1. Field of the Invention

The present invention relates to electronic information management.

2. State of the Art

Email has proven to be the “killer app” of the internet and a prolific productivity tool. Another category of widely-used productivity tools is personal information management tools. Personal information management tools provide for the management of calendar, contacts, to-do lists, notes, etc. Despite the great usefulness of these tools, however, there remains a need for an extensible solution to electronic information management, particularly for legal and financial information presently managed predominantly in paper form.

### SUMMARY OF THE INVENTION

The present invention, generally speaking, provides for a personal electronic repository, or electronic “shoebox,” that receives electronic information from disparate sources and automatically organizes that information in such a way as to enable the owner to readily view the collection of electronic information, find a desired piece of information, act upon a piece of information, etc., all in a secure and controlled way. As opposed to email, which is episodic in nature, the personal electronic repository is thematic in nature. Furthermore, as opposed to personal information management, which is factual in nature, the personal electronic repository is well-suited for information that is transactional in nature. A further characteristic of the shoebox is its long-term nature. Email can be archived, but few individuals expend a concerted effort towards that goal. Personal information management records are fleeting—when a user changes a calendar item or ticks off a to-do item, it's gone. But the shoebox can keep material around for years, so that, for example, the executor of a deceased's estate can locate the deceased's estate documents readily, or divorcing spouses can trace their premarital income. These characteristics (thematic, transactional, long-term) characterize what may be referred to as “life information management,” or “elife.”

### BRIEF DESCRIPTION OF THE DRAWING

The present invention may be further understood from the following description in conjunction with the appended drawing. In the drawing:

FIG. 1 is a block diagram is shown of a life information management system according to one embodiment of the invention;

FIG. 2 is a conceptual diagram illustrating one possible PER user interface;

FIG. 3 illustrates top-level categories in accordance with an exemplary embodiment of the invention;

FIG. 4 illustrates one possible interface screen for controlling insertion privileges; and

FIG. 5 illustrates another possible interface screen for controlling insertion privileges.

### DETAILED DESCRIPTION OF THE PREFERRED EMBODIMENTS

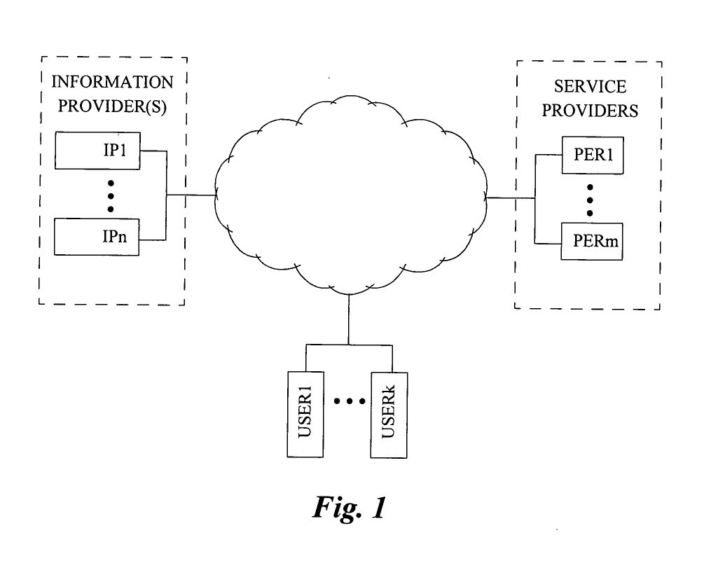

Referring now to FIG. 1, a block diagram is shown of a life information management system according to one embodiment of the invention. The system is preferably Internet based, with access to personal electronic repositories being through the medium of the Internet.

In the system of FIG. 1, multiple information providers are connected to the Internet. Multiple end-users are also connected to the Internet. Each user has access to one or more personal electronic repositorys (PERs). The user may be an individual, and his or her personal electronic repository may be hosted by a service provider (although an owner might host his or her own personal electronic repository by installing appropriate software on a server connected to the Internet). Althoug not indicated in FIG. 1, other service providers may also participate in various roles described below.

The system of FIG. 1 may be email-based or web-based or both. The communication protocols used within the system may be the same as, similar to, or different from existing email and web protocols. Two desirable attributes of the system are: 1) information is securely transmitted using link encyrption; SSL or similar mechanisms may be used for this purpose; and 2) the system is “closed” in the sense that only invited communications are accepted.

Besides viewing his or her own personal information, an end-user may have a consolidated view of information that may be the union of different PERs, e.g., personal information, joint information with the end-user's spouse (which also shows up in the spouse's PER), information on a business venture (which is shared with business partners). Furthermore, just as some internet chat clients integrate AOL Instant Messenger and Yahoo Messenger, it is also possible that a PER aggregator is willing to show an integrated view of PERs offered by different service providers. Hence, while the electronic repository has been described as “personal,” it may be shared by spouses, family members, business partners, etc.

While it is essential that a particular PER has a unique identifier in the service provider's data processing system, it is not essential that the end-users or information providers know or use that unique identifier. In the case of information providers, their knowing the unique identifier may not even be desirable, because such knowledge makes it hard to turn off spammers.

The service provider enables the end-user to obtain one or more identifiers for a particular PER, for use by one or more information providers. Of course, these identifiers need to be unique within the scope of the particular service provider, so that no one issued identifier references two distinct PERs.

It is desirable if some such identifiers are easy to remember by end-users so that they can give out the identifiers in everyday situations where they have no access to computers. For example, an owner may be uniquely identified by his or her telephone number. This unique identifier may be combined with a well-known domain name in order for a party to send an item to an owner's personal electronic repository. For example, if an owner's telephone number were (408) 255-2829, an item might be sent to that owner's personal electronic repository by attaching that item to an email addressed to 4082552829@gotobox.com, where “gotobox” is the well-known domain name of the service provider. The service provider may itself host the personal electronic repository, in which case the item is saved to the personal electronic repository. Alternatively, the service provider may forward some items or even all items to different service providers where the personal electronic repositories are hosted (e.g., Yahoo, Google, MSN), according to forwarding information stored at the service provider.

The owner's telephone number is a convenient choice of identifier because it can be entered using only a numeric keypad. Furthermore, it is already used in many point-of-sale transactions, in lieu of a loyalty card, for example. The identifier need not be manually entered but may be read with or without manual assistance from a contact or contactless magnetic or electronic medium (e.g., a magnetic card, a smartcard, a cellphone or other mobile electronic device, an RFID tag, etc.).

In the case of such easily remembered identifiers, it is desirable if the service provider supplies a mechanism for invalidating or changing the identifier, for example, when an end-user changes the telephone number.

In the case where identifiers are derived from telephone numbers, email addresses, instant messenger names, or other identifiers that must, by their nature, be unique, and an end-user requests the use of an identifier that is already in use by another end-user serviced by the same service provider, it is desirable if the service provider contact the other end-user and ask if the identifier can be transferred. This would, for example, be the case if an end-user relinquishes a telephone number that is later issued to another end-user. In this situation, there is a risk that the new end-user receives information intended for the old user. It is desirable if the service provider takes measures that are designed to mitigate this risk, such as the following.
(1) End-users may be advised not to give out transitory identifiers such as telephone numbers to information providers with whom they expect a long-term relationship such as banks, but to supply a permanent identifier instead.
(2) When transitory identifiers are used in a point-of-sale context, the service agreement with the merchant may require that the transitory identifiers are not reused (unless, of course, end-users supply them again).
(3) Information providers may be required to supply the name, address, or other information about the intended end-user, and the service provider may reject, return, or reroute information that does not match the PER owner.
(4) Information providers may be required to present the transitory identifier to the service provider in return for a different, and preferably non-transitory, identifier that they are to use for inserting information into the PER.
(5) Service providers may communicate invalidated identifiers to information providers, allowing or requiring the information providers to purge the invalidated identifiers from their records.

It is desirable if some identifiers are recognized by the service provider for one-time use, or for use for a limited time only. This measure can limit the introduction of unwanted or “spam” material into a PER.

The effectiveness of the personal electronic repository concept depends on the ability of server software to automatically organize items within a personal electronic repository in accordance with predetermined categories and sub-categories. The sub-category of an item may be indicated, for example, in the subject field of an email to which the item is attached. In the case of multiple attachments, preferably, each attachment is categorized. A hierarchy of categories and sub-categories may be maintained and made available on a web site by the service provider.

Over long periods of use, users may have accumulated large amounts of information in their PERs. A desirable feature is the ability of searching through PERs. Search techniques, such as they are commonly used in web searches, allow users to locate information in their PERs in a way that makes them far superior to paper-based records. Service providers may provide software that end-users install on their own computers to browse and search their PERs.

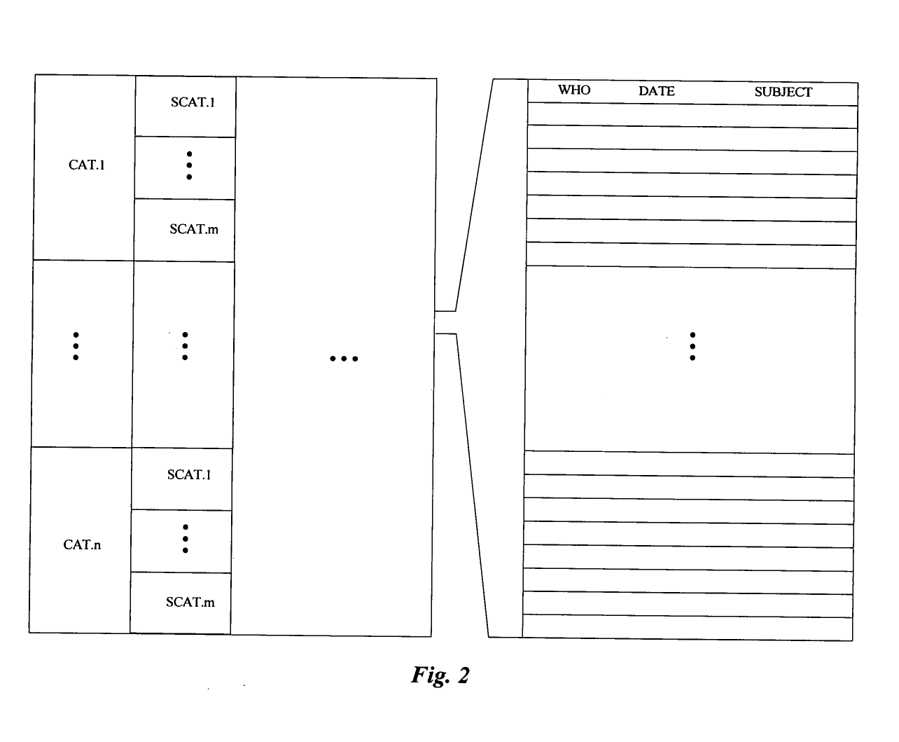

Referring to FIG. 2, a conceptual diagram is shown illustrating one possible PER user interface. In this embodiment, the screen is divided into a number of columns. In column, from left to right, represents a hierarchy level where the hierarchy level decreasing toward the right. Hence, the leftmost column represents the highest level of the hierarchy, illustrated here as being categories of information. When a selection has been made from the leftmost column, the next column to the right is populated with corresponding subcategories of information, and so forth.

When the lowest level of the hierarchy has been reached and a selection made, a display similar to that of many popular email programs is displayed, showing information items by source, date and subject. As compared to conventional email systems, however, in which selection causes a text message to be displayed together with representations of attachments that may be clicked on and viewed, in the present elife system, the focus is preferably on “real” documents, stored for example in HTML, PDF or other convenient format, that are displayed directly upon selection. If desired, a text message may be attached that is viewed in the manner of an attachment in conventional email systems.

To clarify the foregoing distinction in terms of the shoebox analogy, items collected in the shoebox are analogous to attachments in conventional email systems; one can imagine those items having attached to them annotations, analogous to the text of a conventional email. The manner of display described previously reflects the fact that the items are of primary importance, and the associated notations are of secondary importance.

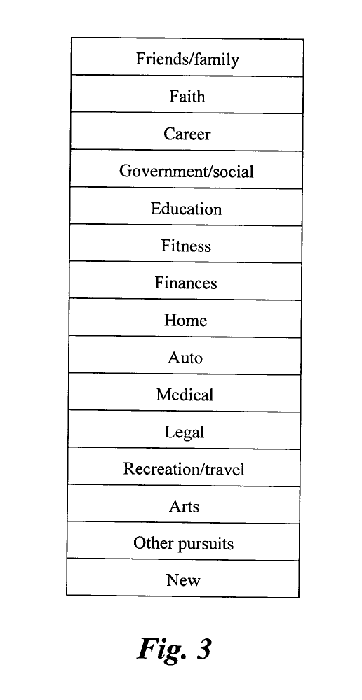

Referring to FIG. 3, top-level categories in accordance with an exemplary embodiment of the invention are shown as including the following: Friends/family; Faith; Career; Government/social; Fitness; Education; Finances; Home; Auto; Medical; Legal; Recreation/travel; Arts; Other pursuits; and New. In an exemplary embodiment, all new items received in the PER, besides being stored under the appropriate category, are also stored under the New category for a user-selectable period of time. Services like Yahoo have their own categorization schemes that may be adapted to or used for the same purpose.

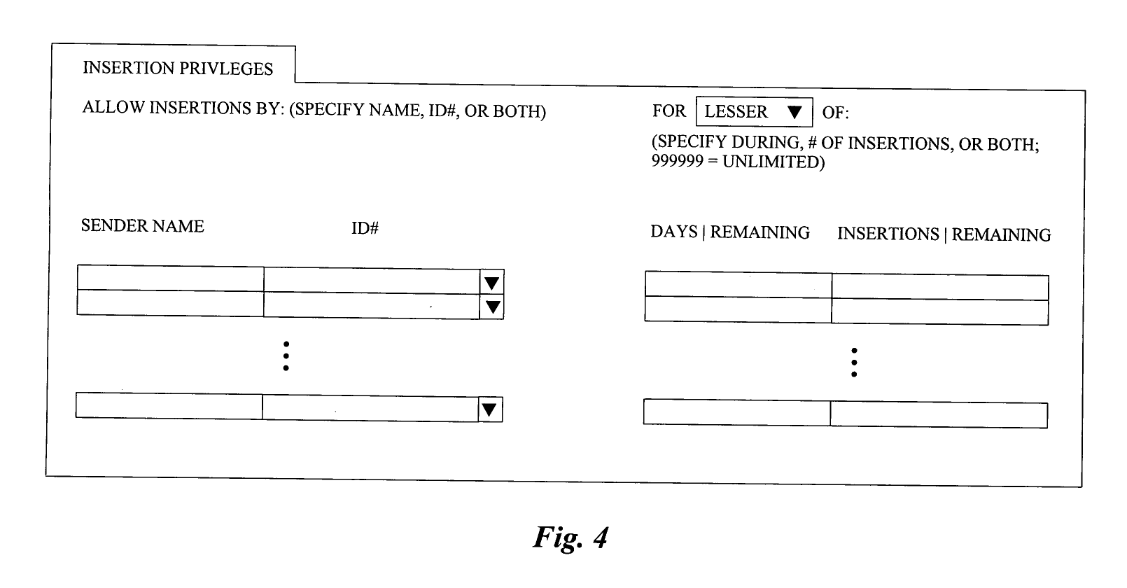

The secured nature of the system of the invention, in one embodiment thereof, is illustrated in FIG. 4, illustrating an “Insertion Privileges” tab. A user might use such a tab to control what information providers are allowed to insert items into the user's PER. Each information provider is identified by name, by an ID#, or both. In order to insert an item into the PER, the item must supply the identical identifiers. The ID# may be chosen by the user, or it may be assigned by the system. In the illustrated embodiment, the pull-down control next to the ID# field causes a unique, psuedorandom ID# to be generated. The user may also specify how long the information provider is to be allowed to insert items into the PER, or the number of items that the information provider is allowed to insert.

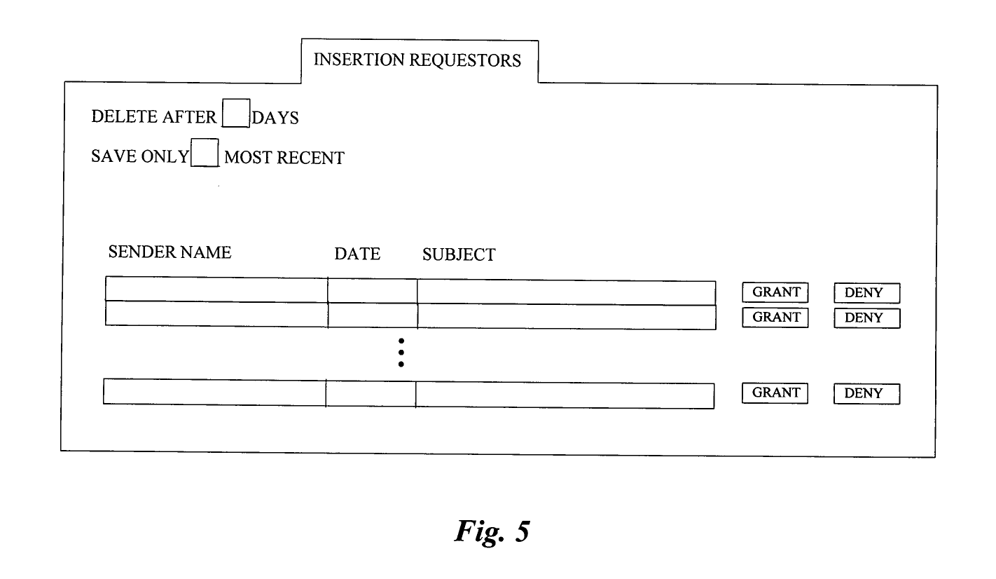

Referring to FIG. 5, an “Insertion Requestors” tab may be used to identify to the user information providers that have made a request to insert one or more items into the users PER but that have not yet been granted access. For each such requester, the user may grant access, in which case the “Insertion Privileges” tab or other similar display would be displayed with an entry created for the new information provider, or the user may deny access, with the option of causing the entry in FIG. 5 to be deleted.

Community of Interest

Success of the elife concept depends on establishing a community of interest between users, service providers, and third party vendors and the like. Users will be attracted by life information management and having ready access to life information from anywhere. Service providers will be attracted by electronic advertising opportunities, customizable based on the identity and residence of the user and what the user is accessing at a particular time. As the collection of items in a PER is typically much more constrained than a collection of items retrieved from a general internet search, electronic advertisements may be more precisely targeted and may be expected to be more effective. Third parties will be attracted by an electronic channel for relationship building that is more differentiated than and hence potentially more effective than simple email.

PERs may also be expected to result in “stickiness” for service providers, or loyalty of end-users to service providers. While people may move their email account, they may be reluctant to go through the trouble of moving their PERs.

Security

The majority of email is now junk email, or “spam,” posing a considerable inconvenience and hindrance to the productive use of email. Spam poses a similar threat to the productive use of personal electronic repositories.

Various security measure may be taken to minimize spam and its attendant inconvenience, including the following:
1) Authenticating the sender. One of the primary problems with spam is that senders of email are anonymous. PER service providers can require that information providers are authenticated, for example by issuing digital signatures, before they are permitted to insert information into end-user PERs.
2) Giving end-users the control to block abusive information providers, or the control of only accepting information providers with whom they have a known business relationship, or putting information that is received from unknown information providers in a separate place where end-users can prescreen it and easily acknowledge or block information providers for future insertions. To facilitate this purpose, service providers may want to issue unique identifiers for information providers.
3) Promulgating and enforcing a code of conduct for information providers that restricts the permitted information, or requires that it is accurately labeled.
4) Charging a modest fee to information providers. A fee (perhaps only a fraction of a penny per insertion) would discourage indiscriminate insertion of information.
5) Permitting end-users to earn fees for receiving information
   Additional Features

Various additional features may be provided to enhance the value of PERs.

One desirable feature is the ability by end-users to annotate the information that is stored in their PERs.

Another desirable feature is the ability by information providers to link information with suggested actions, such as making a payment for an invoice. These actions can be simple web links or they can be executed by software that the service provider makes available for use by end-users. In one embodiment, the user is transported “seamlessly” into the on-line environment of the information provider. An authentication service modelled Microsoft's Passport service or other similar services may be used for this purpose.

Another desirable feature is a backup service in which a service provider backs up the PER data and restores it in case of system failure, and/or enables the end-user to download the PER data and archive it, for example on a personal computer or a CD-ROM, and/or enables the end-user to obtain backups on a tangible medium such as a CD-ROM.

Another desirable feature is a client-side program that integrates the shoebox storage with the local file system, so that the distinction between locally stored documents and documents stored in the PER server becomes transparent to users.

Another desirable feature is the ability for information providers to electronically sign information items, so that they can later be proven to originate from a specific information provider and that they have not been tampered with. This is particularly useful for legal and financial documents since it can be used to definitively prove their authenticity. The service provider may choose to act as, or contract with, a key issuance authority so that public keys of information providers can be managed and released for verification purposes. Alternatively, the PER server may perform the signature function, ensuring that users do not later tamper with documents of legal significance that have been inserted into their PERs.

In this section, we will walk through a typical user interaction in order to demonstrate the utility and novelty of our invention.

The owner of a personal electronic repository-we will call him Owen-logs into his repository at www.shoebox.com. (We refer to the service as the “shoebox”.) He may do so because he periodically inspects recently inserted items and pay his bills, or perhaps he received a notification by email or text message that a new item has arrived.

The shoebox shows a menu with options for viewing new items, searching items, viewing items that are sorted by categories, and for setting personal preferences.

Owen finds a new item, a bank statement. He inspects the categories that the information provider assigned (Bank-Statement—June 2004), and adds his own category (Charity) to help him at tax time. He inspects the statement. One advantage of the shoebox service is that he can view his statements without having to log in to separate web sites for each bank, brokerage, and credit card company. Another advantage is that the document was transmitted securely to him-sending financial documents by email, in contrast, would have been risky. Another advantage is that he is in control of the filing of the statement. It stays in the shoebox for as long as he wants, in the location that he assigns.

Owen finds another item, a credit card bill. This particular item contains a button “Pay me”. Owen clicks on the button, and a browser window for entering payment instructions appears.

Owen finds a third item, a request by his local water company to send his water bill to his shoebox. This invitation might have reached him because he gave the water company a shoebox address for this purpose, or because the water company contracted with the shoebox service provider, and Owen agreed to receive request items of this nature. Owen fills out a web form, agreeing to receive up to 20 items from the water company every year-12 bills, an annual water quality notice, and a few informational or commercial messages.

Because insertion into the shoebox is tightly controlled, Owen does not have to deal with unwanted messages. Information providers register with www.shoebox.com, apply for authentication keys and agree to a code of conduct. If Owen finds that a company has sent him messages other than those that he authorized, he knows that he can report it, and www.shoebox.com will sanction the offender. He also knows that www.shoebox.com only transmits essential information about new companies that try to get permission from him—thus reducing the temptation to use the permission mechanism for spam.

Next, Owen searches for all payments he has ever made to a particular company with whom he is engaged in a billing dispute. All matching items are presented, just as they would in a web search. He finds the item he needs and downloads it. This item has a digital signature, which he can use to prove that he has not tampered with it.

Not all of Owen's business contacts have embraced the shoebox concept, so Owen manually inserts an email message attachment into his shoebox. He could have uploaded the file, but Owen installed a special plugin into his browser that makes it easy to insert the content of web pages and email messages into his shoebox. Some companies even offer rewards for reading messages, but Owen has declined that option in his personal preference settings.

Owen also wants his attorney to insert a document into his shoebox. He calls up his attorney and tells him to email the document to 408-123-4567-1729@shoebox.com. The first ten digits are his phone number, and the last four digits are a one-time code that allow for a single insertion in the next 7 days. Owen can get the one-time code through the shoebox interface, or he can make one up on the spot and enter it into the shoebox interface when he is again online.

Finally, Owen orders a backup of his shoebox. He will receive a CD in the mail in a few days, with a copy of all of his items. This gives Owen the security that he can inspect the important documents that he stored in his shoebox even without internet access, or in the case that www.shoebox.com has technical problems.

This scenario only shows one possible implementation of some of the aspects of the invention.

It will be appreciated by those of ordinary skill in the art that the invention can be embodied in other specific forms without departing from the spirit or essential character thereof. The presently disclosed embodiments are therefore considered in all respects to be illustrative and not restrictive. The scope of the invention is indicated by the appended claims rather than the foregoing description, and all changes which come within the meaning and range of equivalents thereof are intended to be embraced therein.

1. A method of information management for personal electronic repositories comprising:
allowing owners of the repositories to grant permission to information providers to insert items into their repositories;
allowing owners of the repositories to place restrictions on the items that are allowed to be inserted.
allowing authorized information providers to insert items into personal electronic repositories;
and allowing owners of the repositories to access the items that were inserted for them.

2. The method of claim 1, comprising sanctions for information providers that attempt to insert unauthorized items

3. The method of claim 1, comprising owners of the repositories being rewarded for receiving items

4. The method of claim 1, comprising owners of the repositories setting limits on the content or frequency of items that an information provider is allowed to insert

5. The method of claim 1, comprising inserted items being tagged with categories

6. The method of claim 5, wherein said categories includes at least legal and financial categories of information.

7. The method of claim 5, comprising information providers supplying categories for the inserted items

8. The method of claim 5, comprising owners supplying categories for the inserted items

9. The method of claim 5, comprising owners being able to modify categories of inserted items

10. The method of claim 5, comprising owners being able to inspect items sorted by categories

11. The method of claim 1, comprising owners being notified of insertions into their repositories by receiving an electronic communication

12. The method of claim 1, comprising a owner directly viewing items stored in the personal electronic repository without first receiving an electronic communication.

13. The method of claim 1, comprising inserted items allowing an owner to carry out actions by activating control elements

14. The method of claim 1, comprising mailbox owners supplying electronic addresses to information providers for the purpose of inserting items into repositories

15. The method of claim 14, wherein said electronic address is based on a a publicized variant of at least one of the following: a owner's electronic communication address; an owner's physical address, an owner's telephone number.

16. The method of claim 14, wherein said electronic address places restrictions on the frequency or content of the items that may be inserted through it.

17. The method of claim 1, wherein information providers contact repository owners for permission to insert items.

18. The method of claim 17, wherein only restricted information about the permissio request is transmitted to the owner.

19. The method of claim 1, wherein repository owners can insert additional items into their own repositories.

20. The method of claim 19, wherein repository owners use electronic mail for inserting items.

21. The method of claim 19, wherein repository owners use suitably instrumented software for inserting items that they have viewed with said software.

22. The method of claim 1, wherein communication between information providers and repositories is encrypted.

23. The method of claim 1, wherein communication between repositories and their owners is encrypted.

24. The method of claim 1, wherein information providers are authenticated by digital signatures.

25. The method of claim 1, wherein certain items are digitally signed.

26. The method of claim 25, wherein the digital signatures are supplied by the information provider.

27. The method of claim 25, wherein the digital signatures are supplied by the information provider.

28. The method of claim 1, wherein owners can search items in their repositories.

29. The method of claim 1, wherein owners can cause a selected subset of the items in their repositories to be moved to another information processing system.

30. The method of claim 1, wherein owners can cause a selected subset of the items in their repositories to be moved to a tangible information storage medium.

31. The method of claim 1, wherein owners can access items in their repositories from other information processing systems without using a browser.
